(19) United States
(12) Patent Application Publication
(10) Pub. No.: US 2025/0380230 A1
(43) Pub. Date: Dec. 11, 2025

(54) CLASSIFICATION OF AN AP PAIR AS A LINE-OF-SIGHT PAIR OR NON-LINE-OF-SIGHT PAIR

(71) Applicant: HEWLETT PACKARD ENTERPRISE DEVELOPMENT LP, Spring, TX (US)

(72) Inventors: Shivang Aggarwal, Milpitas, CA (US); Mohamed Ibrahim Ahmed, Berkeley Heights, NJ (US); Puneet Sharma, Palo Alto, CA (US); Vikram Raghu, Santa Clara, CA (US); Eldad Perahia, Park City, UT (US)

(21) Appl. No.: 18/734,839

(22) Filed: Jun. 5, 2024

(51) Int. Cl. H04W 56/00; H04W 72/0453; H04W 72/29

(52) U.S. Cl. CPC H04W 56/0035; H04W 56/0045; H04W 72/0453; H04W 72/29

(57) ABSTRACT

An example method and a network device are presented. The example network device configures a first access point (AP) and a second AP to communicate over a first frequency and to receive a first set of Fine Timing Measurement (FTM) metrics between the first AP and the second AP over the first frequency from one or both of the first AP or the second AP. Further, the network device reconfigures the first AP and the second AP to communicate over a second frequency and receives a second set of FTM metrics between the first AP and the second AP over the second frequency from one or both of the first AP or the second AP. Furthermore, the network device determines whether the first AP and the second AP are in Line-of-Sight (LoS) based on the first set of FTM metrics and the second set of FTM metrics.

### BACKGROUND

Typically, a networked infrastructure implementing a Wireless Local Area Network (WLAN) includes access points hosted at several locations in a facility to provide wireless connectivity to client devices. Client devices such as laptops, personal computers, smartphones, or the like, may connect to an access point (AP) in the WLAN to exchange data. With the advancements in Wireless-Fidelity (Wi-Fi) technology, the latest APs are designed to self-locate themselves in the networked infrastructure. In particular, such self-locating APs can identify the relative positions of other APs in the vicinity. Location awareness about the APs in the networked infrastructure helps the client devices connect to the right APs. Also, such location awareness helps network administrators and service providers efficiently locate, update, and/or maintain wireless capable devices such as the APs and client devices in the WLAN.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts an example networked system in which various of the examples presented herein may be implemented.

FIG. 2 depicts a block diagram of an example network device capable of classifying an AP pair as a Line-of-Sight (LoS) pair or a Non-Line-of-Sight (NLoS) pair.

FIG. 3 depicts a flowchart of an example method for classifying an AP pair as a LoS pair or an NLoS pair.

FIG. 4 depicts a flowchart of another example method for classifying an AP pair as a LoS pair or an NLoS pair.

FIG. 5 depicts a block diagram of an example AP capable of timestamping a direct wireless path signal.

FIG. 6 depicts a flowchart of an example method for timestamping a direct wireless path signal.

FIG. 7 depicts a graphical representation showing signal strength values logged by an AP.

FIG. 8 depicts a flowchart of another example method for timestamping a direct wireless path signal.

FIG. 9 depicts a flowchart of an example method for tuning a timestamping parameter such as a threshold value.

FIG. 10 depicts a flowchart of an example method for tuning a timestamping parameter such as a search window.

FIG. 11 depicts an example computing system.

The Figures are not exhaustive and do not limit the present disclosure to the precise form disclosed.

### DETAILED DESCRIPTION

A ranging technique such as the Fine Timing Measurement (FTM) protocol as supported by the Institute of Electrical and Electronics Engineers (IEEE) 802.11mc Specification has been increasingly being implemented to enable APs to determine relative positions. The ranging technique as per the FTM protocol includes exchanging messages between an initiator (e.g., an AP that initiates an FTM session) and a responder (e.g., an AP that responds to the initiator during the FTM session) to determine a distance between the initiator and the one or more responders. Based on the messages exchanged between the initiator and one or more responders, the initiator may determine its position relative to the responders. In some implementations, the distances measured using the FTM technique may be used to automatically build a position map of these APs in the networked infrastructure.

As it is apparent, precise estimation of the distance between two wireless devices, such as APs, is useful for applications such as determining accurate indoor positioning of the APs in a networked infrastructure. This distance estimation is mainly implemented by estimating the time for a wireless signal to travel from one wireless device to another wireless device. In this process of estimation of the travel time of the wireless signal, an accurate timestamping of the wireless signal plays a key role.

Typically, in large-scale indoor deployments, wireless networking devices such as APs are mounted on ceilings and generally oriented facing downward. Moreover, there may be several physical obstructions, such as walls, pillars, and doors, which may not allow clear line-of-sight positioning (i.e., without any physical obstruction) of APs. In such network implementations, a signal from a first AP to a second AP that is not in the line of sight of the first AP may take multiple paths until reaching the second AP. In particular, such a positioning of the APs may potentially hurt the performance of applications that entail implementing ranging measurements for location determination using FTM to estimate pairwise distances between APs and automatically build a map of these APs. Especially, the APs mounted mainly at the ceilings and designed along with their antennas to communicate downwards towards their clients have little chance of having direct wireless path signals between them. With such as network setup, a first strong reception of a signal sent by the first AP at the second AP may not always be through a direct path. The term direct path as used herein may refer to a straight-line path between the two APs. The direct path may be the shortest path between the two APs. A wireless signal that travels along the direct path is hereinafter referred to as a direct wireless path signal.

Traditional techniques generally identify such first strong signal reception to find the distance between the first and the second AP. As the first strong reception may not always be the reception over the direct path between the two APs, any distance estimated using the traditional techniques may be erroneous. Also, the presence of physical obstructions between the APs may make the timestamping task challenging as one of the multipath signals corresponds to the shortest direct path, in contrast, the other signals would have taken non-direct longer paths, potentially resulting in an overestimation of the actual distance.

To address the aforementioned challenges, in examples consistent with the teachings of this disclosure, presented are the methods and systems that aid in more accurate timestamping of the signals and therefore more accurate position determination of the APs. In particular, the proposed solution includes—(A) a classification technique comprising a method and system for classifying a pair of APs as a Line-of-sight (LoS) pair or a non-line-of-sight (NLoS) pair, and (B) a timestamping technique comprising a method and system for accurately timestamping signals received by APs. In some examples, the method and system for accurately timestamping the signals may use the classification of the AP pair to further enhance the accuracy of the timestamping. Additionally, a technique of dynamically tuning timestamping parameters used in the timestamping technique is also presented.

As noted previously, it is not always possible to have LoS coverage indoors, especially over a large area. Therefore, to determine the time of arrival of a direct wireless path signal more accurately, it is beneficial to first determine whether the pair of APs communicating with each other are in line-of-sight or non-line-of-sight from each other. Determining whether the APs are in line-of-sight or non-line-of-sight from each other is generally challenging given that the links between the APs are stably static. Therefore, the traditional solutions that use temporal variations in received signal strength and ranging measurements to determine whether the APs are in line-of-sight or non-line-of-sight from each other cannot be utilized. Instead, the proposed classification technique, in some examples, entails using channel diversity to more accurately determine whether the APs are in line-of-sight or non-line-of-sight. As signal measurements vary significantly when hopping from one channel to another, signal propagation in non-line-of-sight paths will vary as phase and reflection coefficients will fluctuate, resulting in different superpositions of the multipath reception of the signal at the receiving AP.

In particular, the proposed method of determining whether a first AP and a second AP are in line-of-sight includes first configuring, by a network device, the first AP and the second AP to communicate over a first frequency (e.g., over a first Wi-Fi channel). The network device may be any networking device, for example, a WLAN controller or a remote computing system, connected to the first AP and the second AP and configured to communicate therewith. The network device may then configure the first AP and the second AP to execute an FTM sequence and collect a first set of FTM metrics, such as FTM distance and signal strength. The signal strength may be representative of the power (generally expressed in milliwatts or decibel-milliwatts) of the wireless signal received by a given AP, such as the first AP or the second AP. In some examples, the received signal strength may be expressed in the form of a received signal strength indicator (RSSI) value between the first AP and the second AP. The FTM distance is the distance between the first AP and the second AP estimated using the techniques proposed in the FTM protocol. The network device may receive the first set of FTM metrics from one or both of the first AP or the second AP.

Further, the network device may reconfigure the first AP and the second AP to communicate over a second frequency (e.g., over a second Wi-Fi channel) different from the first frequency, execute another FTM sequence, and collect a second set of FTM metrics. Then, based on the first set of FTM metrics and the second set of FTM metrics, the network device may determine whether the first AP and the second AP are in line-of-sight. In particular, the changes in the FTM metrics over different frequencies may be impacted by potential obstacles in the signal. The network device leverages the magnitude of such changes to determine if the first AP and the second AP are in line-of-sight.

Further, in some examples, the proposed timestamping technique relies on the fact that the signal over a direct path precedes all other paths and may not necessarily be the strongest. In other words, in an AP-to-AP ranging setting, the signal component corresponding to the direct path (line-of-sight path) can be significantly attenuated compared to non-line-sight reflections. Therefore, instead of marking the timestamp of the strongest received signal as the time of the direct path arrival, the proposed timestamping technique entails identifying all peaks within a window of a particular size preceding the highest peak. Then, a rising edge of the first (earliest) peak greater than a specific threshold within that window is identified. The timestamp of such a rising edge may be marked as the timestamp of the time of arrival of the direct path.

In particular, in one example implementation, a first AP may receive a plurality of signals (e.g., multipath propagating signals) from a second AP and record signal strength values and time of arrival of the plurality of signals. The first AP may then identify peak signal strength values in a search window preceding the highest signal strength value from the logged signal strength values and select a timestamp at a rising edge of the earliest peak greater than a threshold value as a time of arrival of a direct wireless path signal.

In some examples, the threshold value used in the timestamping technique may be derived from the highest percentiles of the count of values that make up the channel impulse response comprising the plurality of signals. For example, the threshold value may be determined based on the signal strength values in the search window. In particular, the first AP may sort the signal strength values in the search window in ascending order, then select a signal strength from the sorted signal strength values at a predefined percentile of the total count of signal strength values. For example, if a channel impulse response includes one hundred (100) signal strength values, the first AP may sort these signal strength values in ascending order and mark the threshold corresponding to the value that is, say, the 5th highest amongst those 100 values, i.e., the 95th percentile value.

Further, in some examples, the classification of an AP pair—including the first AP and the second AP, being the LoS pair or the NLoS pair helps in tailoring the timestamping described above. In particular, after determining an AP pair classification of the AP pair, the first AP may tune the search window and/or the threshold value based on the AP pair classification to improve the accuracy of the timestamping. The AP pair classification specifies whether the first AP and the second AP are in Line of Sight or Non-Line of Sight from each other. For instance, the search window may be widened in case the first AP and the second AP are not in line-of-sight from each other (i.e., the AP pair being an NLoS pair), or the search window may be narrowed if the first AP and the second AP are in line-of-sight from each other (i.e., the AP pair being a LoS pair). Further, in some examples, the threshold value may be decreased if the AP pair is identified to be the NLoS pair. On the other hand, the threshold value may be increased if the AP pair is identified to be the LoS pair.

For the NLoS AP pair, the direct signal path may be extremely attenuated or completely blocked resulting in an actual timestamp far before the maximum peak. As will be appreciated, enlarging the search window and/or decreasing the thresholding percentile would help timestamping an earlier peak as the direct wireless path signal thereby increasing the chances of accurately identifying the right signal as the direct wireless path signal. On the other hand, narrowing the search window and/or increasing the thresholding percentile for the LoS AP pair would result in timestamping a later peak thereby avoiding some noise and an underestimation of a range measurement. Hence, for both the LoS and NLoS AP pairs, the proposed technique improves the accuracy of timestamping by adaptively tuning the search window and/or the threshold value.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

Before describing examples of the disclosed systems and methods in detail, it is useful to describe an example network installation in which these systems and methods might be implemented in various applications.

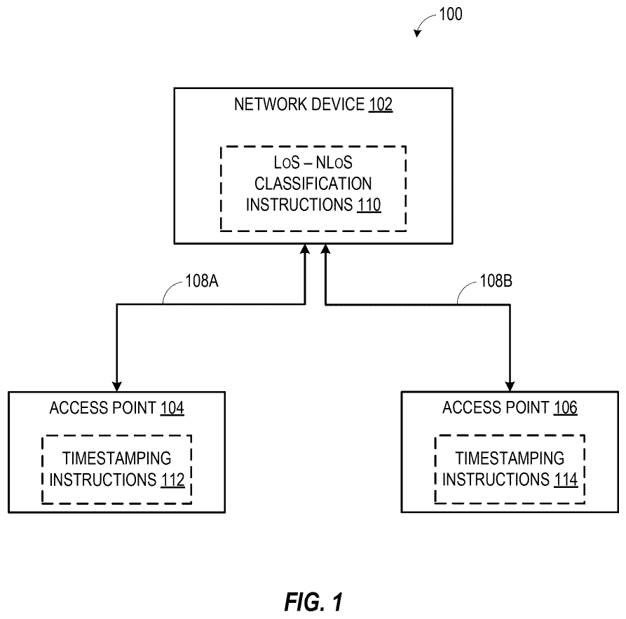

FIG. 1 depicts an example networked system 100 in which various of the examples presented herein may be implemented. The system 100 may be a small-scale network of devices or a large-scale network of devices. The small-scale network of devices may be a home network, for example. The large-scale network of devices may be an organization, university, public utility space (e.g., mall, airport, railway station, bus station, stadium, etc.), or office network hosting a large number of network devices, for example. In some examples, the networked system 100 may be implemented in any setup, for example, in a home setup or an organization, such as a business, educational institution, governmental entity, healthcare facility, or other organization.

The networked system 100 may be a network infrastructure comprising several wireless and wired devices that communicate with each other and/or with any external device or system. In the example implementation of FIG. 1, for illustration purposes, the networked system 100 is shown to include three devices, such as a network device 102 and two access points (APs) 104 and 106. It is to be noted that the examples presented herein are not limited by the specifics (e.g., types and counts) of the devices depicted in FIG. 1. In one example implementation, the network device 102 may be part of a wireless local area network (WLAN) established via the APs 104 and 106. In certain other examples, the network device 102 may be external to the WLAN established via the APs 104 and 106. For instance, the network device 102 may be deployed in a cloud infrastructure and capable of communicating with the APs 104 and 106.

In some examples, the network device 102 may be a network controller, such as a WLAN controller that may be operable to configure and manage the APs 104, 106, and/or other devices such as switches, routers, other APs, and/or client devices if present in the system 100. In some examples, the network device 102 may itself be, or provide the functionality of, an AP. In other implementations, the network device 102 may provide router functionality to the APs 104, 106. Moreover, in some implementations, the network device 102 may be a computer system hosted in a cloud infrastructure remote from the APs 104 and 106.

A wireless networking device, for example, any of the APs 104, 106, may be a combination of hardware, software, and/or firmware that is configured to provide wireless network connectivity to client devices (not shown). In some examples, the APs 104, 106 may be implemented with one or more radios to help the APs 104, 106 communicate with the respective client devices and other wireless-capable devices. Each radio may operate on a respective range of radio frequency ranges, referred to as a Wi-Fi band, for example, the 2.4 GHz Wi-Fi band, 5 GHz Wi-Fi band, the 6 GHz Wi-Fi band, and so on.

The client devices may connect to the APs 104, 106 to communicate with each other and/or with other devices directly or indirectly connected to the APs 104, 106. In particular, the APs 104 and 106 may provide network connectivity to the respective client devices so that the client devices can access the WLAN and/or the Internet via the APs 104 and 106. In some examples, the APs 104, 106, the client devices, and the network device 102 may be configured to communicate using wireless communication techniques specified in one or more Institute of Electrical and Electronics Engineers (IEEE) 802.11 standard specifications. The examples of client devices that may connect to the APs 104, 106 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IOT) devices, and the like.

The APs 104 and 106 may communicate with the network device 102 over the respective links 108A and 108B. The links 108A, 108B may be wired and/or wireless interfaces. For example, the links 108A, 108B may be wired or wireless connections over a public or private network, such as the Internet, or another communication network to allow connectivity between the APs 104, 106, and the network device 102. The links 108A, 108B may include telecommunication lines, such as phone lines, broadcast coaxial cables, fiber optic cables, satellite communications, cellular communications, and the like. In some examples, the links 108A, 108B may include any number of intermediate network devices, such as switches, routers, gateways, servers, and/or controllers.

As it is apparent, in indoor set-ups, especially over a large area, it is not always possible to deploy certain pairs of APs in a Line-of-Sight (LoS) of each other. As previously noted, such a positioning of the APs may potentially hurt the performance of applications that entail implementing ranging measurements for location determination using FTM to estimate pairwise distances between APs and automatically build a map of these APs. Especially, the APs mounted mainly at the ceilings and designed along with their antennas to communicate downwards towards their clients have little chance of having direct wireless path signals between them, which eventually may lead to erroneous identification of a direct wireless path signal and adversely affect accurate timestamping the direct wireless path signal.

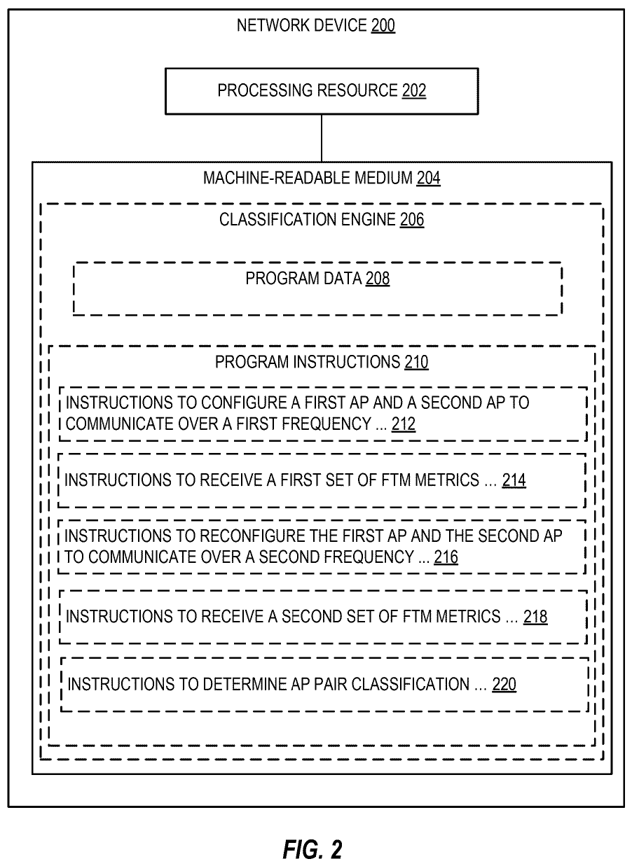

In some examples consistent with the teachings of the present disclosure, the network device 102 may help the APs 104, 106 more accurately identify and timestamp the direct wireless path signals between two APs leading to more accurate position determination of the APs. In particular, the network device 102 may be configured to classify an AP pair formed by the APs 104 and 106 as a LoS pair (i.e., the APs 104 and 106 are in line-of-sight of each other) or a non-line-of-Sight (NLoS) pair (i.e., the APs 104 and 106 are not in line-of-sight of each other) by way of executing the instructions 110 (labeled as “LoS-NLoS classification instructions” in FIG. 1) stored in the network device 102. In particular, the proposed classification technique implemented by the network device 102, leverages channel diversity to more accurately determine whether the APs are in line-of-sight or non-line-of-sight. The signal measurements may vary significantly when conducting measurements over multiple channels. In particular, signal propagation in non-line-of-sight paths generally varies as phase and reflection coefficients will fluctuate, resulting in different superpositions of the multipath reception of the signal at the receiving AP. The network device 102 uses these properties of signal propagation over multiple channels to ascertain whether the APs are in line-of-sight or non-line-of-sight. Additional details about how the network device 102 determines the AP pair classification as described in conjunction with FIGS. 2-4 in section “AP PAIR CLASSIFICATION”.

Further, in some examples, the APs 104 and 106 may implement a technique of identifying a direct wireless path signal between the AP 104 and 106 and timestamping the arrival of such a direct wireless path signal. In some examples, the APs 104 and 106 may respectively execute timestamping instructions 112 and 114 to timestamp the arrival of the direct wireless path signal. The proposed timestamping technique implemented by any of the APs 104, 106 is based on the fact that the signal over a direct path precedes all other paths and may not necessarily be the strongest. In other words, in an AP-to-AP ranging setting, the signal component corresponding to the direct path (line-of-sight path) can be significantly attenuated compared to non-line-sight reflections. Therefore, instead of marking the timestamp of the strongest received signal as the time of the direct path arrival, a receiving AP of the AP 104, 106 identifies all peaks within a window of a particular size preceding the highest peak.

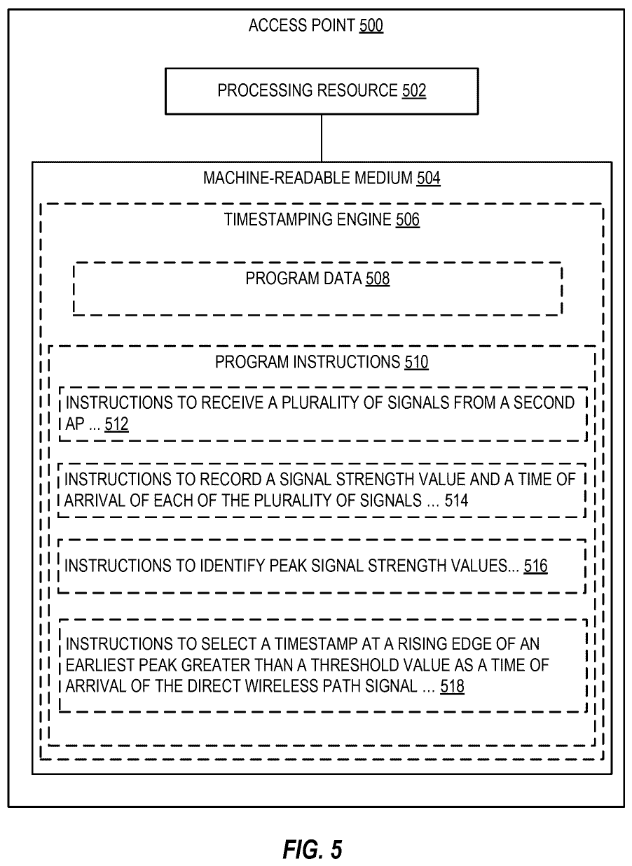

Further, the receiving AP identifies a rising edge of the first (earliest) peak greater than a threshold value within that search window and marks the timestamp of such rising edge as the timestamp of the time of arrival of the direct path. In some examples, the receiving AP of the APs 104 and 106 may derive the threshold value used in the timestamping technique noted earlier based on the highest percentiles of the values that make up the channel impulse response comprising the plurality of signals. For example, the threshold value may be determined based on the signal strength values in the search window. In particular, the first AP may sort the signal strength values in ascending order, and then select, from the sorted signal strength values, a signal strength at a predefined percentile of the total count of signal strength values. Additional details about how the network device 102 identifies and timestamps the direct wireless path signal are described in conjunction with FIGS. 5-8 in a section, “TIMESTAMPING DIRECT WIRELESS PATH SIGNAL”.

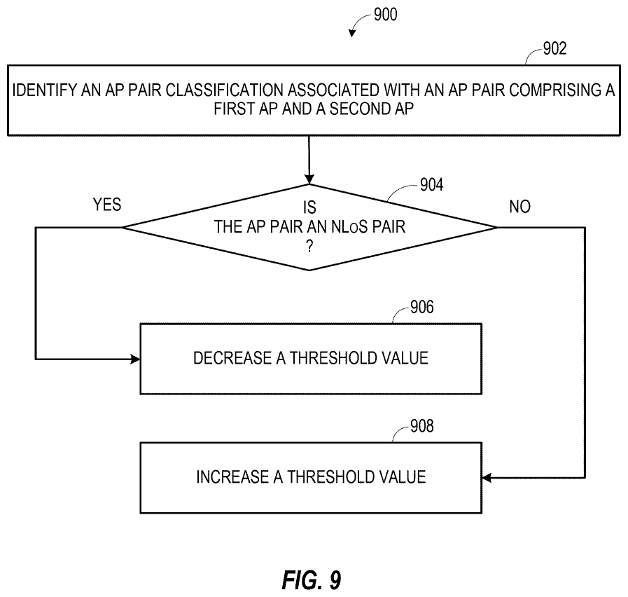

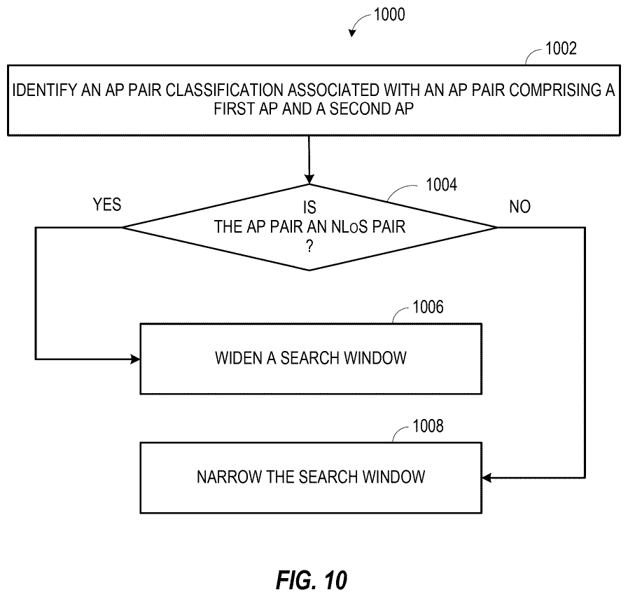

Further, in some examples, the classification of an AP pair comprising the APs 104 and 106, being the LoS pair or the NLoS pair helps in tailoring the timestamping described above. In particular, after determining an AP pair classification of the AP pair, the first AP may tune the search window and/or the threshold value based on the AP pair classification to improve the accuracy of the timestamping. For instance, the search window may be widened in case the APs 104 and 106 form an NLoS pair, or the search window may be narrowed if the APs 104 and 106 form a LoS pair. As will be appreciated, enlarging the search window and/or decreasing the thresholding percentile would help timestamping an earlier peak as the direct wireless path signal thereby increasing the chances of accurately identifying the right signal as the direct wireless path signal. On the other hand, narrowing the search window and/or increasing the thresholding percentile for the LoS AP pair would result in timestamping a later peak thereby avoiding some noise and an underestimation of a range measurement. Hence, for both the LoS and NLoS AP pairs, the proposed technique improves the accuracy of timestamping by adaptively tuning the search window and/or the threshold value. Further, in some examples, the threshold value may be decreased if the APs 104 and 106 form the NLoS pair. On the other hand, the threshold value may be increased if the APs 104 and 106 form the LoS pair. Details about how the network device 102 identifies and timestamps the direct wireless path signal are described in conjunction with FIGS. 9 and 10 in a section, “TUNING OF TIMESTAMPING PARAMETERS”.

For ease of illustration, clarity, and better organization of the information, the description hereinafter is divided into three sections, labeled—“AP PAIR CLASSIFICATION,” “TIMESTAMPING DIRECT WIRELESS PATH SIGNAL,” and “TUNING OF TIMESTAMPING PARAMETERS.” Such division of the description into the above-mentioned multiple sections should not be construed as limiting in any manner.

### AP Pair Classification

This section describes details about how a network device, for example, the network device 102 classifies an AP pair comprising APs 104 and 106 as a LoS pair or an NLoS pair. Example details are described with the help of FIGS. 2-4.

Referring now to FIG. 2, a block diagram of an example network device 200 is presented. The network device 200 of FIG. 2 may be an example representative of the network device 102 of FIG. 1. In certain examples, the network device 200 may be implemented as a controller, such as a WLAN controller. Alternatively, in some implementations, the network device 102 may be a computer system in a cloud infrastructure. In particular, the network device 200 may be configured to determine an AP pair classification for each AP pair in a networked system, for example, the networked system 100 of FIG. 1.

The network device 200 may include a processing resource 202 and/or a machine-readable storage medium 204 for the network device 200 to execute several operations as will be described in the greater details below. More particularly, the network device 200 implements a classification engine 206 to determine the AP pair classifications. For illustration purposes, the classification engine 206 and items inside the classification engine 206 are represented by the dashed outline as they represent digital entities which may be in the form of data and/or instructions that are executable by a physical processing resource, for example, the processing resource 202.

The processing resource 202 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 204, or combinations thereof. In one example, the processing resource 202 may fetch, decode, and execute the instructions stored in the machine-readable storage medium 204 to determine the AP pair classifications. As an alternative or in addition to executing the instructions, the processing resource 202 may include at least one integrated circuit (IC), control logic, electronic circuits, or combinations thereof that include several electronic components for performing the functionalities intended to be performed by the network device 200.

The machine-readable storage medium 204 may be non-transitory and is alternatively referred to as a non-transitory machine-readable storage medium that does not encompass transitory propagating signals. The machine-readable storage medium 204 may be any electronic, magnetic, optical, or another type of storage device that may store data and/or executable instructions. Examples of the machine-readable storage medium 204 may include RAM, NVRAM, EEPROM, a storage drive (e.g., SSD or HDD), a flash memory, and the like. The machine-readable storage medium 204 may be encoded with the classification engine 206 which aids in determining the AP pair classifications. The classification engine 206 includes program data 208 and program instructions 210 which the processing resource 202 uses to determine the AP pair classifications. The program instructions 210 may be an example representative of the LoS-NLoS classification instructions 110 of FIG. 1.

The program data 208 may store a variety of data that may be received, used, and/or generated by the processing resource 202 as the processing resource 202 executes the program instructions 210. By way of example, the processing resource 202 may store data such as FTM metrics received from the APs. Further, the processing resource 202 may store an AP classification database containing information about the AP pair classification for one or more AP pairs in networked system 100.

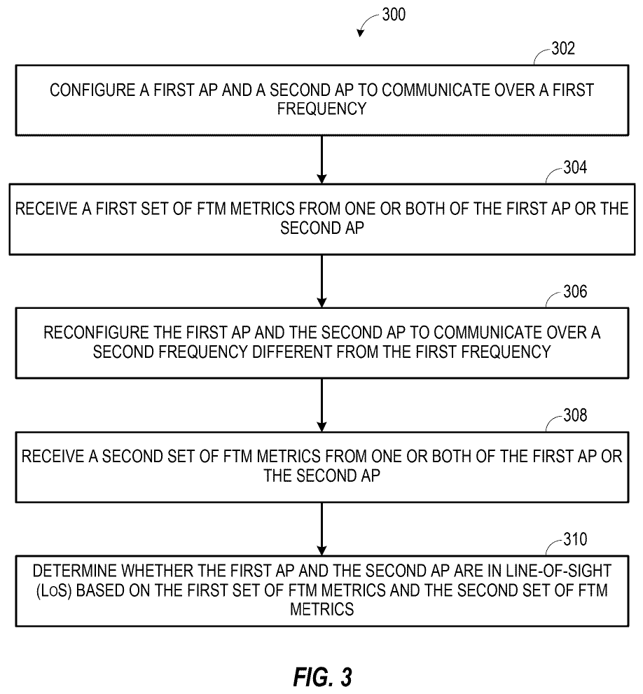

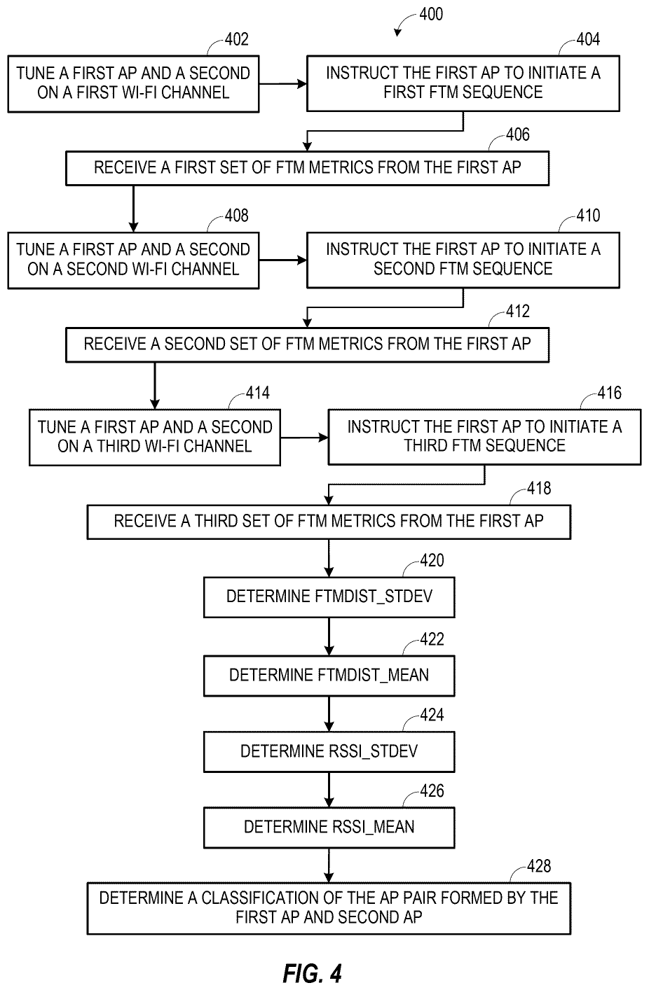

In accordance with examples consistent with the present disclosure, the network device 200 may execute the classification engine 206, by way of the processing resource 202 executing the program instructions 210, to determine a classification of an AP pair, for example, an AP pair formed by the APs 104 and 106 of FIG. 1. In particular, in some examples, the processing resource 202 may execute one or more of the program instructions 210 to perform the method steps described in conjunction with FIGS. 3 and 4. For example, the program instructions 210 may include instructions 212, 214, 216, 218, and 220. In particular, the instructions 212 when executed by the processing resource 202 may cause the processing resource 202 to configure a first AP (e.g., the AP 104 of FIG. 1) and a second AP (e.g., the AP 106 of FIG. 1) to communicate over a first frequency. Further, the instructions 214 when executed by the processing resource 202 may cause the processing resource 202 to receive a first set of FTM metrics between the first AP and the second AP over the first frequency from one or both of the first AP or the second AP.

Furthermore, the instructions 216 when executed by the processing resource 202 may cause the processing resource 202 to reconfigure the first AP and the second AP to communicate over a second frequency different from the first frequency. Further, the instructions 218 when executed by the processing resource 202 may cause the processing resource 202 to receive a second set of FTM metrics between the first AP and the second AP over the second frequency from one or both of the first AP or the second AP. Moreover, the instructions 220 when executed by the processing resource 202 may cause the processing resource 202 to determine whether the first AP and the second AP are in Line-of-Sight (LoS) based on the first set of FTM metrics and the second set of FTM metrics.

Although not shown, in some examples, the machine-readable storage medium 204 may be encoded with certain additional executable instructions to perform any other operations performed by the network device 200, without limiting the scope of the present disclosure.

Turning to FIG. 3, a flowchart of an example method 300 for classifying an AP pair is presented. The steps shown in FIG. 3 may be performed by any suitable device, such as a network device (e.g., the network device 102 of FIG. 1 or the network device 200 of FIG. 2). In some examples, the suitable device may include a processing resource suitable for retrieval and execution of instructions stored in a machine-readable storage medium. The processing resource and the machine-readable storage medium may be example representatives of the processing resource 202 and the machine-readable storage medium 204 of the network device 200. As an alternative or in addition to retrieving and executing instructions, the processing resource may include one or more electronic circuits that include electronic components for performing the functionality of one or more instructions, such as an FPGA, ASIC, or other electronic circuits. For illustration, the examples described in FIG. 3 relate to the classification of an AP pair comprising a first AP (e.g., the AP 104 of FIG. 1) and a second AP (e.g., the AP 106 of FIG. 1).

At step 302, the network device may configure a first AP and a second AP to communicate over a first frequency. In particular, the network device may transmit the same channel settings to both the first AP and the second AP causing the first AP and the second AP to set a first Wi-Fi channel as their operating channel. The channel setting may include specifics about the first Wi-Fi channel, for example, a channel identifier, number and/or a frequency range of the first Wi-Fi channel. The first Wi-Fi channel may be any of the Wi-Fi channels specified in the existing IEEE 802.11 standards or any new channel that may be introduced. Also, in some examples, the network device may instruct the first AP and the second AP to begin a first FTM sequence.

Further, at step 304, the network device may receive a first set of FTM metrics between the first AP and the second AP over the first frequency from one or both of the first AP or the second AP. The APs may generate the FTM metrics by performing ranging during the first FTM sequence per the FTM protocol specified in the IEEE 802.11mc. One of the first AP or the second AP may initiate the FTM by sending a ranging request to the other of the two APs. The wireless device initiating a ranging request is hereinafter referred to as an initiator and a wireless device receiving the ranging request is hereinafter referred to as a responder. The first FTM sequence per the FTM protocol described in IEEE 802.11mc Specification includes exchanging messages between the initiator and the responder to determine the distance between the initiator and the responder. Based on the messages exchanged between the initiator and the responder, the initiator may determine its position relative to the responder. In the given example, any of the first AP or the second AP may function as the initiator and the other one may act as the responder. In particular, in the examples presented herein, the AP acting as the initiator is responsible for determining the FTM metrics such as an FTM distance and a signal strength value between the first AP and the second AP. It is to be noted that the present invention is not limited to the technique of determining the FTM metrics. In some examples, the APs may implement standard techniques and/or protocols such as the one described in IEEE 802.11mc Specification to calculate the FTM distances and the signal strength. The network device may record the first set of FTM metrics in program data, such as the program data 208 (see FIG. 2).

Furthermore, once the first FTM sequence is completed and the first set of FTM metrics are reported, the network device, at step 306, may reconfigure the first AP and the second AP to communicate over a second frequency. In particular, the second frequency is different from the first frequency. In a similar fashion as described in conjunction with the step 302, the network device may send another common channel setting to the first AP and the second AP to reconfigure the first AP and the second AP at step 306. This new channel setting may specify details about a second Wi-Fi channel, for example, a channel identifier, number and/or a frequency range of the second Wi-Fi channel. The second Wi-Fi channel, different from the first Wi-Fi channel, may be any of the Wi-Fi channels specified in the existing IEEE 802.11 standards or any new channel that may be introduced in future. Also, the network device may instruct the first AP and the second AP to begin a second FTM sequence.

Moreover, at step 308, the network device may receive a second set of FTM metrics between the first AP and the second AP over the second frequency from one or both of the first AP or the second AP. In particular, after the reconfiguration and receiving the instruction to perform the second FTM sequence, one of the first AP or the second AP may initiate a ranging request and generate the second set of FTM metrics (e.g., FTM distance and signal strength) by performing ranging as per the FTM protocol specified in the IEEE 802.11mc. The network device may record the second set of FTM metrics in program data, such as the program data 208 (see FIG. 2).

Further, after the first set of FTM metrics and the second set of FTM metrics are received, the network device, at step 310, may determine whether the first AP and the second AP are in line-of-sight (i.e., the AP pair of the first AP and the second AP is a LoS pair) based on the first set of FTM metrics and the second set of FTM metrics. The measurements taken during the FTM sequences may vary significantly when the FTM ranging is performed over different frequencies, for example, over different Wi-Fi channels. This is because signal propagation in the non-line-of-sight paths varies as the phase and reflection coefficients fluctuate, resulting in different superpositions of the multipath reception of the signal at the receiving AP. Accordingly, the network device may look for such variances in the received FTM metrics to determine if the first AP and the second AP are in line-of-sight. In some examples, the network device may derive additional parameters such as standard deviations and mean values of the FTM metrics and classify the AP pair as a LoS pair or an NLoS pair based on such derived parameters. Additional details about classifying the AP pair are described in conjunction with FIG. 4.

Turning to FIG. 4, a flowchart of another example method 400 for classifying an AP pair is presented. The steps shown in FIG. 4 may be performed by any suitable device, such as a network device (e.g., the network device 102 of FIG. 1 or the network device 200 of FIG. 2). In some examples, the suitable device may include a processing resource (e.g., the processing resource 202 of FIG. 2) for retrieval and execution of instructions stored in a machine-readable storage medium (e.g., the machine-readable storage medium 204 of FIG. 2). As an alternative or in addition to retrieving and executing instructions, the processing resource may include one or more electronic circuits that include electronic components for performing the functionality of one or more instructions, such as an FPGA, ASIC, or other electronic circuits. For illustration, the examples described in FIG. 4 correspond to the classification of an AP pair comprising a first AP (e.g., the AP 104 of FIG. 1) and a second AP (e.g., the AP 106 of FIG. 1).

At step 402, the network device may tune the first AP and the second AP to communicate with each other on a first Wi-Fi channel. In particular, for this channel tuning at step 402, the network device may transmit the same channel settings corresponding to the first Wi-Fi channel to both the first AP and the second AP. On receiving the channel setting, the first AP and the second AP may set the first Wi-Fi channel as their operating channels. The channel setting may include specifics about the first Wi-Fi channel, for example, a channel identifier, number and/or a frequency range of the first Wi-Fi channel. The first Wi-Fi channel may be any of the Wi-Fi channels specified in the existing IEEE 802.11 standards or any new channel that may be introduced. By way of example, at step 402, the network device may tune the first AP and the second AP to operate on Channel 36 of the Wi-Fi frequency spectrum.

Further, at step 404, the network device may instruct the first AP to initiate a first FTM sequence with the second AP over the first Wi-Fi channel. The network device may transmit an FTM commencement command to one of the APs (e.g., the first AP) instructing the first AP to begin a first FTM sequence. In response, the first AP may assume the role of an initiator and send an initial FTM request to the second AP thereby intimating the second AP of the start of the first FTM session. The first AP may wait for an acknowledgment from the second AP.

Upon receiving the acknowledgment from the second AP, the first AP may start transmitting one or more ranging packets (also referred to as FTM packets) to the second AP. In one FTM session, the first AP may send one or more FTM packets, sequentially or in parallel. For each FTM packet, the responder may send an acknowledgment to the initiator. Based on timestamps of the FTM packets and respective acknowledgments, the initiator may calculate a first set of FTM metrics, such as an FTM distance and received signal strength (expressed as received signal strength indicator (RSSI) values). The FTM distance may be an estimated distance between the initiator and the responder and is determined using the techniques described in the IEEE standards, such as the IEEE 802.11mc.

The FTM distances and the RSSI values determined during the first FTM sequence are referred to as first FTM distances and first RSSI values, respectively. In one example, the first set of FTM metrics may be calculated for each FTM exchange comprising an FTM packet and respective acknowledgment. Accordingly, if the first FTM sequence includes three FTM exchanges, the initiator may calculate the first FTM distance and the first RSSI value corresponding to each FTM exchange. Table-1 presented below depicts example first set of FTM metrics calculated by the first AP in the first FTM sequence with three FTM exchanges over the first Wi-Fi channel.

TABLE 1
Example first set of FTM metrics

| FTM exchanges in | First FTM | First RSSI values in |
|---|---|---|
| the First FTM | Distances in | decibel milliwatts |
| sequence | Meters (m) | (dBm) |
| 1 | 10 | −50 |
| 2 | 11 | −52 |
| 3 | 10.5 | −51 |

At step 406, the network device may receive the first set of FTM metrics from the first AP. Upon completion of the first FTM sequence, the first AP may transmit the first set of FTM metrics to the network device.

Further, at step 408, the network device may reconfigure the first AP and the second AP by tuning the first AP and the second AP to communicate with each other on a second Wi-Fi channel. In a similar fashion as described in conjunction with the step 402, the network device may send another common channel setting to the first AP and the second AP, however, this time the network device may specify the second Wi-Fi channel that is different from the first Wi-Fi channel. Accordingly, the first AP and the second AP may set the second Wi-Fi channel as their operating channels for future communications. By way of example, for the reconfiguration at step 408, the network device may tune the first AP and the second AP to operate on Channel 48 of the Wi-Fi frequency spectrum.

Furthermore, at step 410, the network device may instruct the first AP to initiate a second FTM sequence with the second AP over the second Wi-Fi channel. In particular, the network device may transmit the FTM commencement command to one of the APs (e.g., the first AP) instructing the first AP to begin the second FTM sequence. The first AP may act as an initiator and complete the second FTM sequence similarly as described in conjunction with step 404. In some examples, the second FTM sequence also includes one or more FTM exchanges comprising FTM packets and respective acknowledgments. During the second FTM sequence, the first AP may determine a second set of FTM metrics (e.g., FTM distances and the RSSI values) over the second Wi-Fi channel. The FTM distances and the RSSI values determined during the second FTM sequence are referred to as second FTM distances and second RSSI values, respectively.

Table-2 presented below depicts example FTM metrics calculated by the first AP in the first FTM sequence with three FTM exchanges over the second Wi-Fi channel.

TABLE 2
Example second set of FTM metrics

| | Second FTM | |
|---|---|---|
| FTM exchanges in the | Distances in Meters | Second RSSI values in |
| Second FTM sequence | (m) | decibel milliwatts (dBm) |
| 1 | 15 | −60 |
| 2 | 16 | −62 |
| 3 | 17 | −61 |

Further, at step 412, the first AP may report the second set of FTM metrics to the network device 102.

Likewise, in some examples, the network device may again reconfigure, at step 414, the first AP and the second AP to communicate over a third Wi-Fi channel (e.g., the Channel 136 of the Wi-Fi spectrum) and instruct, at step 416, the first AP to initiate a third FTM sequence. In response, the first AP may report a third set of FTM metrics (shown in Table 3) to the network device. The FTM distances and the RSSI values determined during the third FTM sequence are referred to as third FTM distances and third RSSI values, respectively.

TABLE 3
Example third set of FTM metrics

| FTM exchanges in the | Third FTM Distances | Third RSSI values in |
|---|---|---|
| Third FTM sequence | in Meters (m) | decibel milliwatts (dBm) |
| 1 | 8 | −45 |
| 2 | 7 | −46 |
| 3 | 6 | −45 |

In some examples, after the FTM metrics are calculated over a predefined number of Wi-Fi channels, the network device may determine classification features at steps 412-418. Example classification features may include a standard deviation of the FTM distances, a mean of the FTM distances, a standard deviation of the RSSI values, and a mean of the RSSI values.

Further, at step 418, the first AP may report the third set of FTM metrics to the network device 102. It may be noted that the present examples are not limited with respect to the number of times the APs may be reconfigured. The number of times the APs may be reconfigured can be customized by a user such as an administrator of the networked system in which the APs are deployed.

For example, at step 420, the network device may determine an FTM distance standard deviation (FTMDIST_STDEV) based on the calculated FTM distances. For example, depending on the number of FTM sequences performed, the network device may use the calculated FTM distances (e.g., the first FTM distances, the second FTM distances, and the third FTM distances) to determine the FTM distance standard deviation. For the values of the FTM distances represented in Tables 1, Table 2, and Table 3, the FTM distance standard deviation for the AP pair is 4.

Further, in some examples, at step 422, the network device may determine an FTM distance mean (FTMDIST_MEAN) based on the calculated FTM distances. For example, depending on the number of FTM sequences performed, the network device may use the available FTM distances (e.g., the first FTM distances, the second FTM distances, and the third FTM distances) to calculate the FTM distance mean. For the values of the FTM distances represented in Tables 1, Table 2, and Table 3, the FTM distance mean for the AP pair is 11.1.

Further, in some examples, at step 424, the network device may determine an RSSI standard deviation (RSSI_STDEV) based on the calculated RSSI values. For example, depending on the number of FTM sequences performed, the network device may use the available RSSI values (e.g., the first RSSI values, the second RSSI values, and the third RSSI values) to calculate the RSSI standard deviation. For the RSSI values represented in Tables 1, Table 2, and Table 3, the RSSI standard deviation for the AP pair is 6.9.

Furthermore, in some examples, at step 426, the network device may determine an RSSI mean (RSSI_MEAN) based on the calculated RSSI values. For example, depending on the number of FTM sequences performed, the network device may use the available RSSI values (e.g., the first RSSI values, the second RSSI values, and the third RSSI values) to calculate the RSSI mean. For the RSSI values represented in Tables 1, Table 2, and Table 3, the RSSI standard deviation for the AP pair is −52.4.

Once the classification features are determined, the network device, at step 428, may determine a classification of the AP pair formed by the first AP and second AP based on the classification features. In one example, the classification features corresponding to the AP pair (the first AP and the second AP) may define a feature vector corresponding to the AP pair (FV_AP1AP2) as shown in Equation 1.

$$FV\_AP 1 AP 2 = [ FTMDIST\_STDEV , FTMDIST\_MEAN , RSSI\_STDEV , RSSI\_MEAN ] \qquad Equation ( 1 )$$

For the examples presented with the help of Tables 1-3, the feature vector corresponding to the AP pair formed by the first AP and the second AP may be [4, 11.1, 6.9, −52.4]. As will be understood, typically in a given small-scale or large-scale network there may generally be more than two APs forming more than two AP pairs. Accordingly, using the similar technique described above, the network device may also calculate the feature vectors corresponding to several other AP pairs in a networked system, for example, the networked system 100 of FIG. 1.

After calculating the feature vectors for the AP pairs in the networked system, the network device may apply a clustering technique to the feature vectors to group APs in two clusters-one indicating the AP pair being a LoS pair and the other indicating the AP pair being an NLoS pair. Examples of the clustering technique implemented by the network device may include centroid-based clustering, density-based clustering, distribution-based clustering, or combinations thereof. It is to be noted that, the network device is envisioned to implement any suitable clustering technique capable of classifying the APs pairs based on the determined feature vectors.

In certain other examples, the network device may be implemented with artificial intelligence to classify the AP pair based on the classification features. In such examples, the network device may implement one or more machine-learning (ML) models which are trained to classify AP pairs based on the classification features during a training phase. Such trained ML models may be deployed on the network device to infer a classification for a given AP pair based on the respective classification features.

### Timestamping Direct Wireless Path Signal

This section describes a technique of timestamping a direct wireless path signal by an AP, for example, a receiving AP of the APs 104, 106. As previously noted, the direct path may refer to a straight-line path between the transmitting AP and the receiving AP. Example details of the proposed timestamping technique are described in conjunction with FIGS. 5-8.

Referring to FIG. 5, a block diagram of an example AP 500 is presented. The AP 500 of FIG. 5 may be any wireless networking device, for example, any of the APs 104, 106 of FIG. 1, that received multipath wireless signals and need to timestamp a signal of the multipath signals that corresponds to the direct path between the two APs.

The AP 500 may include a processing resource 502 and/or a machine-readable storage medium 504 to execute several operations as will be described in the greater details below. More particularly, the AP 500 implements a timestamping engine 506 to identify and timestamp a direct wireless path signal received from a transmitting AP. For illustration purposes, the timestamping engine 506 and items inside the timestamping engine 506 are represented by the dashed outline as they represent digital entities which may be in the form of data and/or instructions that are executable by a physical processing resource, for example, the processing resource 502.

The processing resource 502 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 504, or combinations thereof. In one example, the processing resource 502 may fetch, decode, and execute the instructions stored in the machine-readable storage medium 504 to identify and timestamp a direct wireless path signal received from a transmitting AP. As an alternative or in addition to executing the instructions, the processing resource 502 may include at least one integrated circuit (IC), control logic, electronic circuits, or combinations thereof that include several electronic components for performing the functionalities intended to be performed by the AP 500.

The machine-readable storage medium 504 may be non-transitory and is alternatively referred to as a non-transitory machine-readable storage medium that does not encompass transitory propagating signals. The machine-readable storage medium 504 may be any electronic, magnetic, optical, or another type of storage device that may store data and/or executable instructions. Examples of the machine-readable storage medium 504 may include RAM, NVRAM, EEPROM, a storage drive (e.g., SSD or HDD), a flash memory, and the like. The machine-readable storage medium 504 may be encoded with the timestamping engine 506 which aids in identifying and timestamping a direct wireless path signal. The timestamping engine 506 includes program data 508 and program instructions 510 to manage the roaming of the client devices.

The program data 508 may store a variety of data that may be received, used, and/or generated by the processing resource 502 as the processing resource 502 executes the program instructions 510. In some examples, the program data 508 may include a database, also referred to as a signal log, which stores the signal strength value and the time of arrival of each of the plurality of signals. Further, in some examples, the processing resource 502 may store, in the program data 510, the timestamp values of direct wireless path signals that the processing resource 502 may identify by executing the program instructions. Furthermore, in some examples, the processing resource 502 may store information such as the threshold value and the search window in the program data 510.

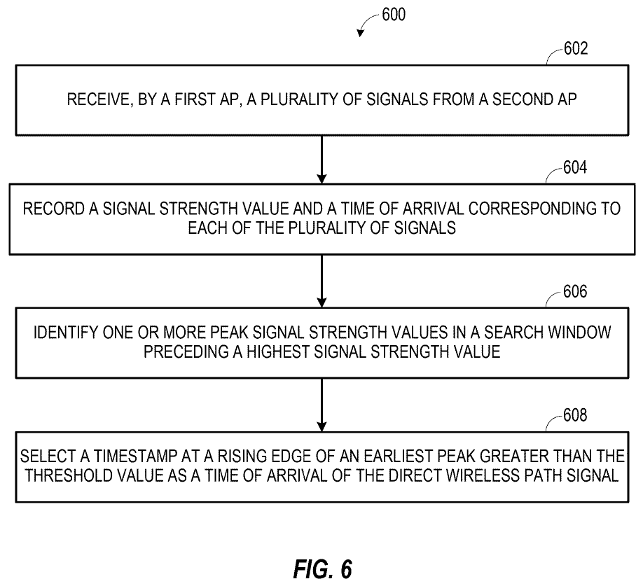

In accordance with examples consistent with the present disclosure, the AP 500 may execute the timestamping engine 506, by way of the processing resource 502 executing the program instructions 510, to determine a classification of an AP pair, for example, an AP pair formed by the APs 104 and 106 of FIG. 1. In particular, in some examples, the processing resource 502 may execute one or more of the program instructions 510 to perform the method steps described in conjunction with FIGS. 6. For example, the program instructions 510 may include instructions 512, 514, 516, and 518. In particular, the instructions 512 when executed by the processing resource 502 may cause the processing resource 502 to receive a plurality of signals from a second AP. Further, the instructions 514 when executed by the processing resource 502 may cause the processing resource 502 to record a signal strength value and a time of arrival corresponding to each of the plurality of signals. Furthermore, the instructions 516 when executed by the processing resource 502 may cause the processing resource 502 to identify one or more peak signal strength values in a search window preceding a highest signal strength value from the signal strength values. Moreover, the instructions 518 when executed by the processing resource 502 may cause the processing resource 502 to select a timestamp at a rising edge of an earliest peak greater than a threshold value as a time of arrival of the direct wireless path signal.

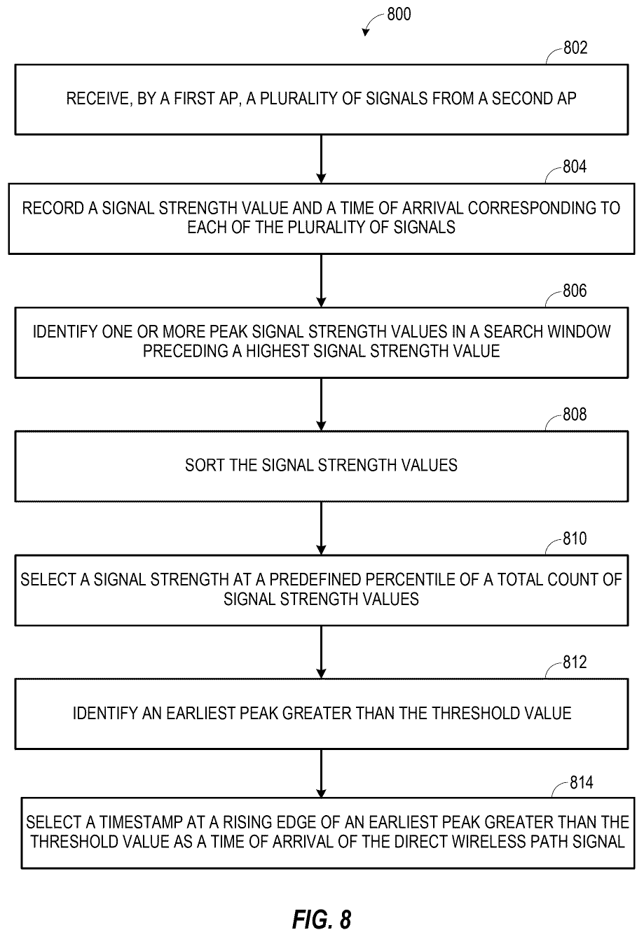

Although not shown, in some examples, the machine-readable storage medium 504 may be encoded with certain additional executable instructions to perform any other operations performed by the AP 500 (e.g., one or more of the steps described in FIGS. 8-10), without limiting the scope of the present disclosure.

Turning to FIG. 6, a flowchart of an example method 600 for timestamping the direct wireless path signals is presented. The method described in FIG. 6 may be performed by an AP that receives multipath propagating signals. The multipath propagating signals represent multiple propagations (i.e., signals) of an omnidirectionally transmitted packet from a transmitter (e.g., another AP or wireless communication device). One of these wireless signals may travel via the straight-line path (i.e., the direct path) whereas the other wireless signals may propagate via non-direct longer paths. A wireless signal that propagates via the shortest path or the direct path is referred to as a direct wireless path signal.

By way of example, the multipath propagating signals may be multiple propagations of an omnidirectionally transmitted packet, such as an FTM packet or acknowledgment of the FTM packet. The distance between the transmitting AP and the receiving AP may be determined more accurately based on such direct-path wireless signals compared to one calculated based on other non-direct-path wireless signals. By executing the method 600 of FIG. 6, the receiving AP can identify and timestamp the direct wireless path signal from the received multipath propagating signals. In some examples, the timestamp of the direct wireless path signal may then be utilized to estimate the distance between the transmitting AP and the receiving AP per the FTM techniques described in the IEEE 802.11 Standard Specifications.

The suitable device for executing the method 600 of FIG. 6 may include a processing resource for retrieving and executing instructions stored in a machine-readable storage medium. The processing resource and the machine-readable storage medium may be example representatives of the processing resource 502 and the machine-readable storage medium 504 of the AP 500. As an alternative or in addition to retrieving and executing instructions, the processing resource may include one or more electronic circuits that include electronic components for performing the functionality of one or more instructions, such as an FPGA, ASIC, or other electronic circuits.

At step 602, a first AP receives a plurality of signals (e.g., multipath propagating signals) from a second AP. The first AP is an AP that receives the multipath propagating signals and is also alternatively referred to as a receiving AP. Further, the second AP is an AP that transmits an omnidirectional packet and is also alternatively referred to as a transmitting AP. Depending on the paths the multipath propagating signals take to travel to the first AP, the multipath propagating signals may arrive at the first AP at various time intervals. For example, a path length and/or the reflections caused by obstacles such as walls, doors, etc., and their material properties may introduce delays of varying magnitudes to the signals, causing the packets to reach the first AP at various time intervals. It may be noted that only one of these wireless signals may have traveled via the direct path and the rest of the multipath propagating signals may have taken non-direct longer paths. Due to this, a signal with the highest signal strength may not always be the one that travels through the shortest or the direct wireless path. Hence, such a signal with the highest signal strength may not be beneficial in accurately timestamping the direct wireless path signal. Therefore, the first AP may execute the following steps to find the direct wireless path signal and timestamp it.

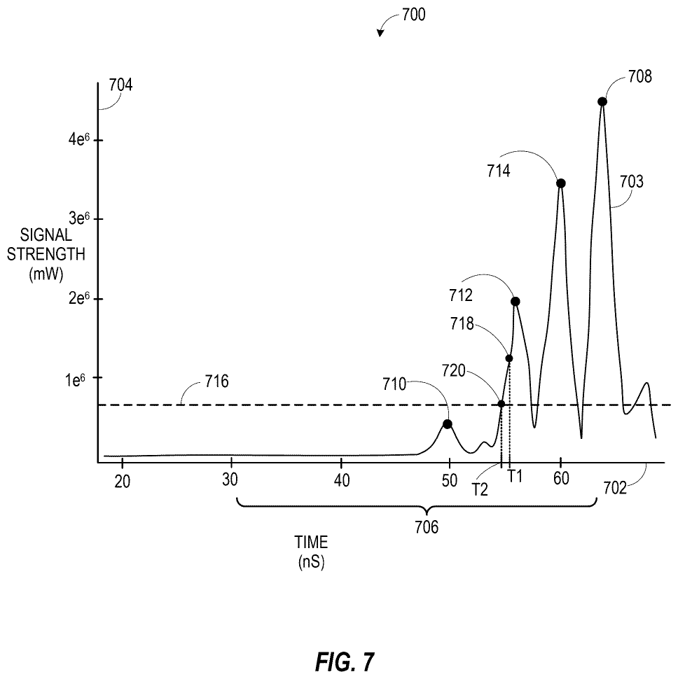

Further, at step 604, the first AP may record a signal strength value and a time of arrival corresponding to each of the plurality of signals. In particular, the first AP maintains a database, also referred to as a signal log, which stores the signal strength value and the time of arrival of each of the plurality of signals. In some examples, a log entry containing the signal strength value and the time of arrival corresponding to a signal may be created into the signal log after the signal is received at step 602. FIG. 7, represents a graphical representation 700 depicting the signal strength values logged by the first AP. For ease of illustration, the graphical representation 700 of FIG. 7 is described concurrently with FIG. 7. Referring to FIG. 7, the reference numerals 702 and 704 represent an X-axis and a Y-axis, respectively. The X-axis 702 represents signal strength in milliwatts (mW), and the Y-axis 704 represents time in nanoseconds (ns). Further, a line graph 703 represents variations in the signal strength values of the received wireless signals by the first AP.

Referring back to FIG. 6, at step 606, the first AP may identify one or more peak signal strength values in a search window preceding a highest signal strength value from the signal strength values. The term search window used herein may refer to a predetermined time duration that depends on a threshold value which is a function of the signal strength values (described in conjunction with FIG. 7). As will be understood, the multipath propagating signals may undergo varying levels of attenuation while propagating via respective wireless paths, and due to the presence of several obstacles in the respective wireless paths. Accordingly, the signal strength values of the received signals may vary. From the signal strength values, the first AP may find peak values (see FIG. 7) in the search window preceding the highest signal strength value. For example, in the graphical representation 700 of FIG. 7, the search window is marked with a reference numeral 706, and the highest signal strength value (also referred to as “maximum peak”) is marked with the reference numeral 708. Further, the reference numerals 710, 712, and 714 represent peak signal strength values (also referred to as ‘peaks’) before a wireless signal with the maximum peak 708.

After the peak values are identified, the first AP, at step 608, may select a timestamp at a rising edge of an earliest peak greater than the threshold value as a time of arrival of the direct wireless path signal. The threshold value is calculated based on the signal strength values of the multipath propagating signals received by the first AP which is described in conjunction with a method described in FIG. 8. In some examples, the first AP may identify the first wireless signal received during the rising edge of the earliest peak greater than the threshold value. Turning to FIG. 7, the threshold value is represented by a horizontal dashed line 716. Accordingly, the first AP may select a wireless signal with the signal strength value marked with a dot 718 as the direct wireless path signal. Further, the first AP may select the time of arrival (marked with label ‘T1’) of this direct wireless path signal (i.e., the projection of dot 718 on the X-axis 702) as the timestamp of the direct wireless path signal. In another example, the first AP may select a time (marked with label ‘T2’) at the beginning (marked with reference numeral 720) of the rising edge above the threshold value as the timestamp of the direct wireless path signal.

Referring to FIG. 8, a flowchart of an example method 800 for timestamping the direct wireless path signal is presented. The method 800 of FIG. 8 is an example representative of the method 600 of FIG. 6. In particular, the method described in FIG. 8 may be performed by an AP (e.g., any of the APs 104, 106) that receives multipath propagating signals and timestamps the arrival of the direct wireless path signals. Certain details previously described in FIG. 6 are not repeated herein for the sake of brevity. Further, the method 800 describes certain additional steps useful for the AP to determine the threshold value. A suitable device for executing the method of FIG. 8 may include a processing resource for retrieving and executing instructions stored in a machine-readable storage medium. The processing resource and the machine-readable storage medium may be example representatives of the processing resource 502 and the machine-readable storage medium 504 of the AP 500. As an alternative or in addition to retrieving and executing instructions, the processing resource may include one or more electronic circuits that include electronic components for performing the functionality of one or more instructions, such as an FPGA, ASIC, or other electronic circuits.

At step 802, a first AP (i.e., a receiving AP—an AP that receives multipath propagating signals) receives a plurality of signals (e.g., multipath propagating signals) from a second AP (i.e., a transmitting—an AP that transmits an omnidirectional packet).

Further, at step 804, the first AP may record a signal strength value and a time of arrival corresponding to each of the plurality of signals. In particular, the first AP maintains a signal log which stores the signal strength value and the time of arrival of each of the plurality of signals. In some examples, a log entry containing the signal strength value and the time of arrival corresponding to a signal may be created into the signal log after the signal is received at step 602.

Furthermore, at step 806, the first AP may identify one or more peak signal strength values in a search window preceding a highest signal strength value from the signal strength values. As will be understood, the multipath propagating signals may undergo varying levels of attenuation while propagating via respective wireless paths, and due to the presence of several obstacles in the respective wireless paths. Accordingly, the signal strength values of the received signals may vary. From the different signal strength values, the first AP may find peaks (see FIG. 7) in the search window preceding the highest signal strength value.

Moreover, the first AP may determine a threshold value based on the signal strength values of the signals received by the first AP. In particular, to determine the threshold value, the first AP, at step 808, may sort the signal strength values in ascending order. After the signal strength values are sorted in ascending order, the first AP, at step 810, may select a signal strength at a predefined percentile of a total count of signal strength values. For example, if the predefined percentile is set to 95, the first AP may select the signal value at the 5^{th} percentile to be the threshold value. In one example, the predefined percentile may be selected by a user (e.g., an administrator). Further, in some examples, the predefined percentile may be customizable and/or dynamically adapted based on an AP classification (described earlier). The first AP may then use this threshold value to find and timestamp the direct wireless path signal.

In particular, at step 812, the first AP may identify an earliest peak greater than the threshold value. The first AP may compare the recorded signal values against the threshold value in the order of their arrival time to identify the earliest peak that is greater than the threshold value.

Further, at step 814, the first AP may select a timestamp at a rising edge of the earliest peak greater than the threshold value as a time of arrival of the direct wireless path signal. In some examples, the first AP may identify the first wireless signal received on the rising edge of the earliest peak greater than the threshold value. In another example, the first AP may select a time at the beginning of the rising edge above the threshold value as the timestamp of the direct wireless path signal.

### Tuning of Timestamping Parameters

The classification of an AP pair (described in the section—AP PAIR CLASSIFICATION)—including the first AP and the second AP, being the LoS pair or the NLoS may be useful in tailoring the timestamping of the direct wireless path signal (described in the section—TIMESTAMPING DIRECT WIRELESS PATH SIGNAL). In particular, the first AP may be configured to identify AP pair classification associated with an AP pair [including the first AP (which is the receiving AP) and a second AP (which is the transmitting AP sending the multipath propagating signals to the receiving AP)] and tune the timestamping parameters such as the search window and/or the threshold value based on the AP pair classification to improve the accuracy of the timestamping.

FIG. 9 depicts a flowchart of an example method 900 for tuning a timestamping parameter such as a threshold value usable in the methods of FIGS. 6 and 8. The method 900 of FIG. 9 may be performed by a suitable device, for example, an AP that performs the methods described in FIG. 6 or FIG. 8. The suitable device may include a processing resource for retrieving and executing instructions stored in a machine-readable storage medium. The processing resource and the machine-readable storage medium may be example representatives of the processing resource 502 and the machine-readable storage medium 504 of the AP 500. As an alternative or in addition to retrieving and executing instructions, the processing resource may include one or more electronic circuits that include electronic components for performing the functionality of one or more instructions, such as an FPGA, ASIC, or other electronic circuits.

In particular, at step 902, the first AP may identify an AP pair classification associated with an AP pair comprising the first AP (i.e., a receiving AP) and the second AP (i.e., the transmitting AP—an AP that transmits the propagating signals to the first AP). The network device stores an AP pair classification for each AP pair in a networked system, for example, the networked system 100 of FIG. 1 in the AP pair classification database. In one example, the AP pair classification may be similarly determined by the network device as described in the section—AP PAIR CLASSIFICATION. In another example, a user such as a network administrator may specify the AP pair classification manually, and such manually specified AP pair classification may be stored in the AP pair classification database. In one example, the first AP sends an AP pair classification query to the network device (e.g., the network device 102 of FIG. 1). In response to the AP pair classification query, the network device may send the AP pair classification to the first AP.

In another example, the first AP may look up an AP pair classification store to find a classification tag associated with the AP pair (i.e., the AP pair comprising the first AP and the second AP). In particular, the APs in the networked system may locally maintain a list of their neighbor APs. Also, the APs may download the AP pair classification for their respective neighbor APs from the network device such as the network device 102. Likewise, the first AP may have also downloaded the AP pair classification corresponding to each of the neighbor APs from the network device into its AP pair classification store. Accordingly, to identify the AP pair classification of the first AP and the second AP, the first AP may search into its AP pair classification store to identify the respective AP pair classification.

Further, at step 904, the first AP may perform a check to determine if the AP pair classification indicates the AP pair is an NLoS pair.

At step 904, if it is determined that the AP pair classification indicates the AP pair is an NLoS pair, the first AP, at step 906, may decrease the threshold value. On the other hand, at step 904, if it is determined that the AP pair classification indicates the AP pair is not an NLoS pair (i.e., the AP pair is a LoS pair), the first AP, at step 908, may increase the threshold value. In some examples, the amount of increase or decrease in the threshold value may be customizable and controlled by the user. In some examples, the first AP may increase (at step 908) or decrease (at step 906) the threshold value by a fixed predefined amount.

For the NLoS AP pair, the direct signal path may be extremely attenuated or completely blocked resulting in an actual timestamp far before the maximum peak. As will be appreciated, decreasing the thresholding percentile would help timestamping an earlier peak as the direct wireless path signal thereby increasing the chances of accurately identifying the right signal as the direct wireless path signal. Such a decrease in the threshold value may improve the accuracy of timestamping.

FIG. 10 depicts a flowchart of an example method 1000 for tuning a timestamping parameter such as a search window usable in the methods of FIGS. 6 and 8. The method 1000 of FIG. 10 may be performed by a suitable device, for example, an AP that performs the methods described in FIG. 6 or FIG. 8. The suitable device may include a processing resource for retrieving and executing instructions stored in a machine-readable storage medium. The processing resource and the machine-readable storage medium may be example representatives of the processing resource 502 and the machine-readable storage medium 504 of the AP 500. As an alternative or in addition to retrieving and executing instructions, the processing resource may include one or more electronic circuits that include electronic components for performing the functionality of one or more instructions, such as an FPGA, ASIC, or other electronic circuits.

In particular, at step 1002, the first AP may identify an AP pair classification associated with an AP pair comprising the first AP (i.e., a receiving AP) and the second AP (i.e., the transmitting AP—an AP that transmits the propagating signals to the first AP). The first AP may apply one or more of the techniques described in conjunction with step 902 of FIG. 9, to identify the AP pair classification.

Further, at step 1004, the first AP may perform a check to determine if the AP pair classification indicates the AP pair is an NLoS pair.

At step 1004, if it is determined that the AP pair classification indicates the AP pair is an NLoS pair, the first AP, at step 1006, may widen (or enlarge) the search window. On the other hand, at step 1004, if it is determined that the AP pair classification indicates the AP pair is not an NLoS pair (i.e., the AP pair is a LoS pair), the first AP, at step 1008, may narrow the search window. In some examples, the amount of increase or decrease in the search window may be customizable and controlled by the user. In some examples, the first AP may widen (at step 1006) or narrow (at step 1008) the search window by a fixed predefined duration.

As previously noted, for the NLoS AP pair, the direct signal path may be extremely attenuated or completely blocked resulting in an actual timestamp far before the maximum peak. As will be appreciated, narrowing the search window for the LoS AP pair would result in timestamping a peak closer to the maximum peak as the direct wireless path signal, thereby avoiding some noise and underestimating the range measurement. Also, widening the search window for the NLoS pair causes the first AP to timestamp an earlier peak as the direct wireless path signal thereby increasing the chances of accurately identifying the right signal as the direct wireless path signal. Hence, for both the LoS and NLoS AP pairs, the proposed technique improves the accuracy of timestamping by adaptively tuning the search window and/or the threshold value.

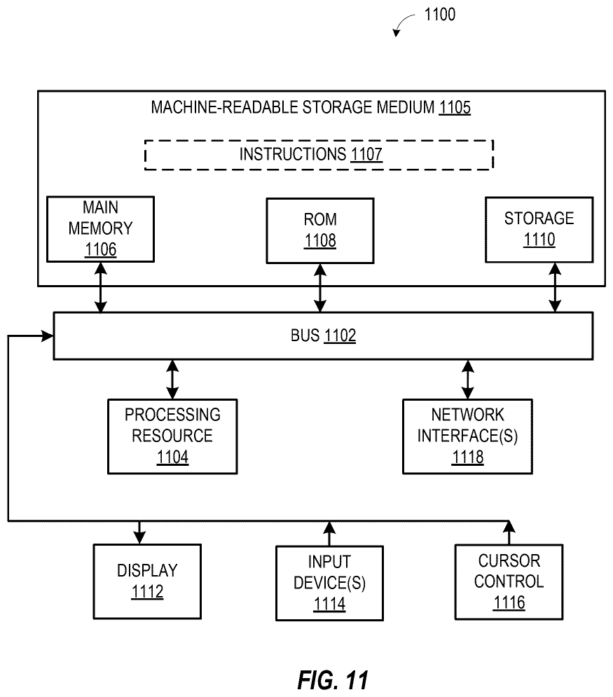

FIG. 11 depicts a block diagram of an example computing system 1100 in which various of the examples described herein may be implemented. In one example, the computing system 1100 may be configured to operate as a network device such as the network device 102 of FIG. 1 and can perform various operations described in one or more of the earlier drawings (e.g., FIGS. 2-4). In another example, the computing system 1100 may be an access point such as any of the AP 104, 106 and can perform various operations described in one or more of the earlier drawings (e.g., FIGS. 5-10). Examples of the devices and/or systems that may be implemented as the computing system 1100 may include, desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, virtual terminals, video game consoles, virtual assistants, IoT devices, and the like.

The computing system 1100 may include a bus 1102 or other communication mechanisms for communicating information, a hardware processor, also referred to as processing resource 1104, and a machine-readable storage medium 1105 coupled to the bus 1102 for processing information. In some examples, the processing resource 1104 may include one or more CPUs, semiconductor-based microprocessors, and/or other hardware devices suitable for retrieval and execution of instructions stored in the machine-readable storage medium 1105. The processing resource 1104 may fetch, decode, and execute instructions to configure MLO for SSIDs. As an alternative or in addition to retrieving and executing instructions, the processing resource 1104 may include one or more electronic circuits that include electronic components for performing the functionality of one or more instructions, such as an FPGA, an ASIC, or other electronic circuits.

In some examples, the machine-readable storage medium 1105 may include a main memory 1106, such as a RAM, cache and/or other dynamic storage devices, coupled to the bus 1102 for storing information and instructions to be executed by the processing resource 1104. The main memory 1106 may also be used for storing temporary variables or other intermediate information during the execution of instructions to be executed by the processing resource 1104. Such instructions, when stored in storage media accessible to the processing resource 1104, render the computing system 1100 into a special-purpose machine that is customized to perform the operations specified in the instructions. The machine-readable storage medium 1105 may further include a read-only memory (ROM) 1108 or other static storage device coupled to the bus 1102 for storing static information and instructions for the processing resource 1104. Further, in the machine-readable storage medium 1105, a storage device 1110, such as a magnetic disk, optical disk, or USB thumb drive (Flash drive), etc., may be provided and coupled to the bus 1102 for storing information and instructions.

In some examples, the bus 1102 of the computing system 1100 may be coupled to a display 1112, such as a liquid crystal display (LCD) (or touch-sensitive screen), for displaying information to a computer user. In some examples, an input device 1114, including alphanumeric and other keys (physical or software generated and displayed on a touch-sensitive screen), may be coupled to the bus 1102 for communicating information and command selections to the processing resource 1104. Also, in some examples, another type of user input device such as a cursor control 1116 may be connected to the bus 1102. The cursor control 1116 may be a mouse, a trackball, or cursor direction keys. The cursor control 1116 may communicate direction information and command selections to the processing resource 1104 for controlling cursor movement on the display 1112. In some other examples, the same direction information and command selections as cursor control may be implemented via receiving touches on a touch screen without a cursor.

In some examples, the computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 1100 also includes a network interface 1118 coupled to bus 1102. The network interface 1118 provides a two-way data communication coupling to one or more network links that are connected to one or more local networks. For example, the network interface 1118 may be an integrated services digital network (ISDN) card, cable modem, satellite modem, or a modem to provide a data communication connection to a corresponding type of telephone line. As another example, the network interface 1118 may be a local area network (LAN) card or a wireless communication unit (e.g., Wi-Fi chip/module).

In some examples, the machine-readable storage medium 1105 (e.g., one or more of the main memory 1106, the ROM 1108, or the storage device 1110) stores instructions 1107 (marked with dashed outline) which when executed by the processing resource 1104 may cause the processing resource 1104 to execute one or more of the methods/operations described hereinabove. The instructions 1107 may be stored on any of the main memory 1106, the ROM 1108, or the storage device 1110. In some examples, the instructions 1107 may be distributed across one or more of the main memory 1106, the ROM 1108, or the storage device 1110. In some examples, the instructions 1107 when executed by the processing resource 1104 may cause the processing resource 1104 to perform one or more of the methods described in any of FIGS. 3 and 4. In some other examples, the instructions 1107 when executed by the processing resource 1104 may cause the processing resource 1104 to perform one or more of the methods described in any of FIGS. 6, 8, 9, 10.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

1. A method comprising:
configuring, by a network device, a first access point (AP) and a second AP to communicate over a first frequency;
receiving, by the network device, a first set of Fine Timing Measurement (FTM) metrics between the first AP and the second AP over the first frequency from one or both of the first AP or the second AP;
reconfiguring, by the network device, the first AP and the second AP to communicate over a second frequency different from the first frequency;
receiving, by the network device, a second set of FTM metrics between the first AP and the second AP over the second frequency from one or both of the first AP or the second AP; and
determining, by the network device, whether the first AP and the second AP are in Line-of-Sight (LoS) based on the first set of FTM metrics and the second set of FTM metrics.

2. The method of claim 1, wherein the configuring comprises tuning the first AP and the second AP to communicate with each other on a first Wireless Fidelity (Wi-Fi) channel.

3. The method of claim 1, wherein the reconfiguring comprises tuning the first AP and the second AP to communicate with each other on a second Wi-Fi channel.

4. The method of claim 1, further comprising:
instructing, by the network device, the first AP to initiate a first FTM sequence with the second AP over the first frequency after configuring the first AP and the second AP to communicate over the first frequency; and
instructing, by the network device, the first AP to initiate a second FTM sequence with the second AP over the second frequency after reconfiguring the first AP and the second AP to communicate over the second frequency, wherein each of the first FTM sequence and the second FTM sequence comprises one or more FTM exchanges.

5. The method of claim 4, wherein:
the first set of FTM metrics comprises one or more first FTM distances between the first AP and the second AP, one or more first signal strength values between the first AP and the second AP, or both determined during the first FTM sequence; and
the second set of FTM metrics comprises one or more of second FTM distances between the first AP and the second AP or one or more second signal strength values between the first AP and the second AP, or both determined during the second FTM sequence.

6. The method of claim 5, further comprising calculating, by the network device, one or more of:
a first standard deviation of the one or more first FTM distances and the one or more second FTM distances; and
a first mean of the one or more first FTM distances and the one or more second FTM distances.

7. The method of claim 6, further comprising classifying a pair of the first AP and the second AP into one of two clusters based on one or more of the first standard deviation or the first mean.

8. The method of claim 6, further comprising calculating one or more of:
a second standard deviation of the one or more first signal strength values and the one or more first signal strength values; and
a second mean of the one or more first signal strength values and the one or more first signal strength values.

9. The method of claim 8, further comprising classifying a pair of the first AP and the second AP into two clusters based on one or more of the first standard deviation, the first mean, the second standard deviation, or the second mean using a clustering technique.

10. The method of claim 9, wherein the clustering technique comprises Centroid-based clustering, Density-based clustering, Distribution-based Clustering, or combinations thereof.

11. A network device comprising:
a machine-readable storage medium storing executable instructions; and
a processing resource coupled to the machine-readable storage medium, wherein the processing resource is configured to execute one or more of the instructions to:
configure a first access point (AP) and a second AP to communicate over a first frequency;
receive a first set of Fine Timing Measurement (FTM) metrics between the first AP and the second AP over the first frequency from one or both of the first AP or the second AP;
reconfigure the first AP and the second AP to communicate over a second frequency different from the first frequency;
receive a second set of FTM metrics between the first AP and the second AP over the second frequency from one or both of the first AP or the second AP; and
determine whether the first AP and the second AP are in Line-of-Sight (LoS) based on the first set of FTM metrics and the second set of FTM metrics.

12. The network device of claim 11, wherein:
to configure the first AP and the second AP, the processing resource is configured to execute one or more of the instructions to tune the first AP and the second AP to communicate with each other on a first Wireless Fidelity (Wi-Fi) channel; and
to reconfigure the first AP and the second AP, the processing resource is configured to execute one or more of the instructions to tune the first AP and the second AP to communicate with each other on a second Wi-Fi channel.

13. The network device of claim 11, wherein the processing resource is configured to execute one or more of the instructions to:
instruct the first AP to initiate a first FTM sequence with the second AP over the first frequency after configuring the first AP and the second AP to communicate over the first frequency; and
instruct the first AP to initiate a second FTM sequence with the second AP over the second frequency after reconfiguring the first AP and the second AP to communicate over the second frequency, wherein each of the first FTM sequence and the second FTM sequence comprises one or more FTM exchanges.

14. The network device of claim 13, wherein:
the first set of FTM metrics comprises one or more first FTM distances between the first AP and the second AP, one or more first signal strength values between the first AP and the second AP, or both determined during the first FTM sequence; and
the second set of FTM metrics comprises one or more of second FTM distances between the first AP and the second AP or one or more second signal strength values between the first AP and the second AP, or both determined during the second FTM sequence.

15. The network device of claim 14, wherein the processing resource is configured to execute one or more of the instructions to calculate one or more of:
a first standard deviation of the one or more first FTM distances and the one or more second FTM distances;
a first mean of the one or more first FTM distances and the one or more second FTM distances;
a second standard deviation of the one or more first signal strength values and the one or more first signal strength values; and
a second mean of the one or more first signal strength values and the one or more first signal strength values.

16. The network device of claim 15, wherein the processing resource is configured to execute one or more of the instructions to classify a pair of the first AP and the second AP into two clusters based on one or more of the first standard deviation, the first mean, the second standard deviation, or the second mean.

17. A non-transitory machine-readable medium storing instructions executable by a processing resource, the instructions comprising:
instructions to tune a first access point (AP) and a second AP to communicate over a first Wireless-Fidelity (Wi-Fi) channel;
instructions to receive a first set of Fine Timing Measurement (FTM) metrics between the first AP and the second AP over the first Wi-Fi channel from one or both of the first AP or the second AP;
instructions to tune the first AP and the second AP to communicate over a second Wi-Fi channel different from the first Wi-Fi channel;
instructions to receive a second set of FTM metrics between the first AP and the second AP over the second Wi-Fi channel from one or both of the first AP or the second AP; and
instructions to determine whether the first AP and the second AP are in Line-of-Sight (LoS) based on the first set of FTM metrics and the second set of FTM metrics.

18. The non-transitory machine-readable medium of claim 17, wherein:
the first set of FTM metrics comprises one or more first FTM distances between the first AP and the second AP, one or more first signal strength values between the first AP and the second AP, or both determined during a first FTM sequence; and
the second set of FTM metrics comprises one or more of second FTM distances between the first AP and the second AP or one or more second signal strength values between the first AP and the second AP, or both determined during a second FTM sequence.

19. The non-transitory machine-readable medium of claim 18, wherein the instructions further comprise:
instructions to calculate a first standard deviation of the one or more first FTM distances and the one or more second FTM distances;
instructions to calculate a first mean of the one or more first FTM distances and the one or more second FTM distances;
instructions to calculate a second standard deviation of the one or more first signal strength values and the one or more first signal strength values; and
instructions to calculate a second mean of the one or more first signal strength values and the one or more first signal strength values.

20. The non-transitory machine-readable medium of claim 19, wherein the instructions further comprise instructions to classify a pair of the first AP and the second AP into two clusters based on one or more of the first standard deviation, the first mean, the second standard deviation, or the second mean.
